(19) United States
(12) Patent Application Publication
(10) Pub. No.: US 2026/0208283 A1
(43) Pub. Date: Jul. 23, 2026

(54) METHOD AND DEVICE FOR WELDING COMPONENTS, WHICH CAN BE TRAVELLED UPON, OF A TRACK BY FLASH BUTT WELDING

(71) Applicant: voestalpine Railway Systems GmbH, Leoben (AT)

(72) Inventor: Erik STOCKER, Spielberg (AT)

(73) Assignee: voestalpine Railway Systems GmbH, Wien (AT)

(21) Appl. No.: 19/144,632

(22) PCT Filed: Dec. 20, 2023
(86) PCT No.: PCT/IB2023/063024

§ 371 Date: Jun. 30, 2025

(30) Foreign Application Priority Data
Dec. 30, 2022 (DE) GM 92/2022

(51) Int. Cl. B23K 11/04; B23K 31/02; B23K 37/003; B23K 101/26; C21D 1/40; C21D 9/04

(52) U.S. Cl. CPC B23K 11/046; B23K 31/02; B23K 37/003; C21D 1/40; C21D 9/04; B23K 2101/26

(57) ABSTRACT

A method for welding components, which can be travelled upon, of a track by flash butt welding in a welding device, comprising the steps of straight flashing, preheating, flashing and upsetting, wherein the upsetting process generates a welding region, whereupon the welding region, from the welding heat, is subjected to a cooling step in which an austenitic structure of the welding region is converted into a pearlite structure, whereupon the welding region is subjected to a reheating step in which the welding region is heated to above the Ac1 conversion temperature, wherein the heating is performed by electrical resistance heating in the welding device using the power source that is used for the straight flashing, preheating and flashing, whereupon a region of the component, the region coming into contact with a wheel and being in particular a rail head, is subjected to cooling in the welding region.

### CROSS-REFERENCE TO RELATED APPLICATIONS

The present application is a national phase application of PCT Application No. PCT/IB2023/063024, filed Dec. 20, 2023, entitled “METHOD AND DEVICE FOR WELDING COMPONENTS, WHICH CAN BE TRAVELLED UPON, OF A TRACK BY FLASH BUTT WELDING”, which claims the benefit of Austrian Utility Model Patent Application No. GM 92/2022, filed Dec. 30, 2022, each of which is incorporated by reference in its entirety.

### BACKGROUND OF THE INVENTION

### 1. Field of the Invention

The invention relates to a method and a device for welding components, which can be travelled upon, of a track, in particular rails, by means of flash butt welding.

### 2. Description of the Related Art

In the flash butt welding of parts to be butt-jointed together, such as rails, the joining parts are clamped in a butt welding machine and brought into contact after switching on the current, wherein in a first phase a straight flashing takes place, which serves to level out irregularities in the abutting surfaces of the connection. In a subsequent preheating phase, the energized joining parts are moved against each other with a certain contact force and pulled apart again, and a high heating occurs at the contact points due to the electrical resistance. This process is repeated several times until sufficient heating has formed over the entire cross-section and the abutting surfaces have become so warm that the energy supplied is sufficient to initiate the subsequent flash-off process. In the flashing phase, the material is melted off at the abutting surfaces at intense sparking and brought to welding temperature as uniformly as possible, whereupon the actual welding process takes place in an upsetting process, in which the abutting surfaces of the two parts, brought to welding temperature, are pressed together with the required welding force after switching off the current. The molten material regions are pressed out of the contact surface regions into a welding bead.

After upsetting, the contact force between the joining parts is maintained for some time or gradually or continuously reduced.

The welding process causes microstructural changes in the welding joint and in the adjacent heat-affected zones, which adversely affect the component properties, in particular the hardness. The welding region, i.e. the welding joint and the adjacent heat-affected zones, is therefore subjected to heat treatment in some cases. This usually comprises normalization, consisting of austenitizing and subsequent accelerated cooling in air, thereby eliminating microstructural irregularities and achieving a fine-grained, uniform microstructure with reproducible strength and deformability properties.

Normalization is carried out in a heat treatment device separate from the butt welding machine. The heating is usually carried out by means of inductive heating using an inductor adapted to the rail cross-section or by means of a burner flame. Alternatively, the use of a resistance heater has also been proposed.

There is a need for improved heat treatment, which leads to an increase in hardness at the rail head and a fine-grained pearlitic structure with a very fine ferrite network.

### SUMMARY OF THE INVENTION

The present invention therefore aims to further develop a flash butt welding method with respect to said properties.

In order to achieve this object, the invention provides, according to a first aspect, a method for welding components, which can be travelled upon, of a track, in particular rails, by flash butt welding in a welding device, comprising the steps of straight flashing, preheating, flashing and upsetting, wherein the upsetting process generates a welding region, whereupon the welding region, from the welding heat, is subjected to a cooling step in which an austenitic structure of the welding region is converted into a pearlite structure, whereupon the welding region is subjected to a reheating step in which the welding region is heated to above the Ac1 conversion temperature, wherein the heating is performed by electrical resistance heating in the welding device using the power source that is used for the straight flashing, preheating and flashing, whereupon a region of the component coming into contact with a wheel, particularly a rail head is subjected to cooling in the welding region.

The invention is thus based, on the one hand, on a special design of the individual steps of a heat treatment and, on the other hand, on the idea of carrying out the heat treatment in interaction with the welding process in the welding device itself. Because the welded rails or track components for the heat treatment do not have to be removed from the welding device, the reheating step can be carried out immediately after the cooling step. Herein, cooling is carried out, which is just sufficient for an austenitic structure of the welding region to be converted into a pearlite structure. Further cooling, which would take place during a period of time required for the displacement of the rails into a position removed from the welding device, does not have to be accepted. This increases energy efficiency because the residual heat lost in this way does not have to be reintroduced in the subsequent reheating process.

Preferably, the cooling step immediately following the welding process is carried out in ambient air with natural convection.

According to a preferred embodiment, the cooling step is carried out to a temperature of the welding region of less than 500° C. This ensures that the cooling curve in a time-temperature conversion (TTC) diagram leads into or through the pearlite region, particularly into the region where complete conversion of the austenite to pearlite is ensured. The cooling step is thus only aborted after the complete conversion of austenite into pearlite has taken place.

The duration of the cooling step is advantageously 120-240 seconds.

In order to minimize the above-mentioned energy loss due to excessive cooling of the welding region, it is preferably provided that the reheating step is started immediately after completion of the cooling step at a temperature of the welding region of >400° C., in particular at a temperature of the welding region of between 400° C. and 500° C.

According to the invention, the heat is supplied for the reheating step by electrical resistance heating using the welding power source used for straight flashing, preheating and flashing. In this case, a direct current is preferably passed through the welding region. However, alternating current may also be used. The current is preferably supplied in a plurality of successive current pulses, between which there are currentless periods. By suitably selecting the pulse shape and the duration of the individual current pulses in relation to the length of the currentless periods, the heat supply can be controlled, in particular with regard to a desired heating characteristic, such as a desired temperature curve over time. According to the invention, the reheating step is carried out in such a way that the welding region is heated to above the Ac1 conversion temperature. The Ac1 conversion temperature is understood to be the temperature of a steel at which the formation of austenite begins during heating.

In this case, the welding region may be heated to a temperature of >850° C., preferably to a temperature of 900-950° C., in the reheating step.

Preferably, the duration of the reheating step is a maximum of 30 seconds, in particular 25-30 seconds.

Preferably, it may also be provided that the reheating step is carried out at an average heating rate of 13-20° C./sec in order to promote the formation of a fine-grained austenite and to limit the heat input to the welding region as far as possible. These and higher heating rates are easily achieved by the power source.

The last step of the heat treatment is formed by cooling the region of the component that comes into contact with a wheel, in particular the rail head. Cooling may take place either in the welding device or in a position of the track component removed from the welding device. Cooling can be accelerated or not accelerated depending on the type of steel. Accelerated cooling results in an increase in the hardness of the rail head and a fine-grained pearlitic structure with a very fine ferrite network.

In the case of accelerated cooling of the region of the component that comes into contact with a wheel, in particular of the rail head, it is preferably possible to proceed in such a way that a region without wheel contact, in particular a rail foot, of the track component is subjected to a slower cooling in the welding region than the region of the component that comes into contact with a wheel, in particular the rail head. This results in a tougher structure on the rail foot. The rail foot may also be cooled in an accelerated manner, but at a lower cooling speed than the rail head, or the cooling of the rail foot may take place naturally, i.e. in still air without forced convection.

The accelerated cooling is preferably carried out in such a way that the pearlite region “P” in the time-temperature conversion diagram is traversed in such a way that at least 90% of the fine pearlitic microstructure is present (preferably after approx. 80 sec). Thereafter, the accelerated cooling may be continued until a temperature of less than 500° C., preferably less than 400° C., particularly preferably less than 350° C., is reached. Preferably, the duration of the accelerated cooling is 80-150 seconds.

The accelerated cooling of the region of the component that comes into contact with a wheel, in particular the rail head, preferably takes place by forced convection of a cooling gas, preferably air.

The method according to the invention is particularly suitable for the flash butt welding of railway rails to one another and for the flash butt welding of railway rails to other parts of the track, such as, for example, intersections and the like, as well as for their production, since particularly restrictedly accessible welding regions of intersections can only be uniformly heated with difficulty by inductors or gas burners.

The method according to the invention without accelerated cooling is particularly suitable for the flash butt welding of track components consisting of type R260 steel or similar naturally hard rail steels with a C content of <0.75%.

The method according to the invention with accelerated cooling is particularly suitable for the flash butt welding of track components consisting of R350HT steel or similar head-hardened rail steels with a C content of >0.75%.

According to a second aspect of the invention, a welding device for welding components, which can be travelled upon, of a track by flash butt welding is provided, comprising a welding power source, a feed device for pressing the track components against one another and a programmable control unit for controlling a time sequence of current pulses of the welding power source and a feed movement of the feed device, characterized in that the control unit is configured to control the feed device and the welding power source in a welding phase in order to carry out the steps of straight flashing, preheating, flashing and upsetting, a welding region being generated by the upsetting process, to control the welding power source in a subsequent reheating phase in order to carry out a reheating step, and to start the reheating step after a cooling step in which the welding region is cooled from the welding heat. The welding device according to the invention is particularly suitable for carrying out a method according to the first aspect of the invention.

Preferred developments of the welding device are specified below and substantially correspond to features for carrying out preferred embodiments of the method according to the invention described above.

Preferably, the control unit has stored a metallurgical specification of the track components to be welded and is configured to heat the welding region to above the Ac1 conversion temperature in the reheating step.

It is preferably provided that the control unit is configured to start the reheating step after an austenitic structure of the welding region has been converted into a pearlite structure in the cooling step, wherein a residual heat present in the welding region from the welding phase is preferably usable.

Preferably, it is provided that the control unit is configured to carry out the cooling step to a temperature of the welding region of less than 500° C.

Preferably, it is provided that the control unit is configured to carry out the reheating step for a duration of 120-240 seconds.

It is preferably provided that the control unit is configured to start the reheating step immediately after completion of the cooling step and preferably at a fixed temporal distance from the welding step at a temperature of the welding region of between 400° C. and 500° C.

Preferably, it is provided that the control unit is configured to carry out the reheating step for a duration of a maximum of 30 seconds.

Preferably, the control unit is configured to carry out the reheating step at an average heating rate of 13-20° C./sec.

Preferably, it is provided that the control unit is configured to heat the welding region to a temperature of >850° C., preferably to a temperature of 900-950° C., in the reheating step.

The welding device preferably also comprises a cooling device for accelerated cooling of the welding region, wherein the control unit cooperates with the cooling device in such a way that a region of the component, in particular the rail head, that comes into contact with a wheel is subjected to accelerated cooling in the welding region after the reheating step.

It is preferably provided that the cooling device for blowing a gas or gas mixture is formed on at least one section of the welding region in order to accelerate its cooling.

It is preferably provided that at least one flow rate of the gas or gas mixture or its pressure is controllable by the cooling device.

It is preferably provided that the control unit is configured to carry out the accelerated cooling to a temperature of less than 500° C., preferably less than 400° C., particularly preferably less than 350° C., wherein the duration of the accelerated cooling is preferably 80-150 seconds.

The execution of a welding with subsequent heat treatment of the welding region in the same welding machine allows the control of the welding machine to comply with a certain time sequence of welding and heat treatment. Thus, current pulses of the power source for a known combination of components can cause both the desired welding and the required temperature control for the heat treatment of the welding region according to a sequence that is fixed in time. As part of the creation of a program for controlling the welding machine, the desired temporal temperature profile of the welding region is determined once for a specific combination of two components by a time sequence of current pulses and their pulse shapes. The heat treatment at a fixed temporal distance from the weld ensures a constant initial condition for the heat treatment in the sense of an existing welding heat or temperature distribution in the welding region. Due to the adherence to a programmed time sequence of welding and heat treatment ensured by the welding machine control system and the time-defined sequence of current pulses for the heat treatment, there is no need to measure or regulate the temperature of the welding region.

Optionally, in a further embodiment of the welding machine, at least one controllable cooling device is provided for accelerating a cooling of the welding region, wherein said cooling device can be controlled by the control of the welding machine. When creating a program for controlling the welding machine, the desired temporal temperature profile of the welding region is determined once for a specific combination of two components, in addition to a time sequence of current pulses and their pulse shapes, by the time sequence of operating states of the cooling device.

As a result, welding with heat treatment with high robustness and repeatability is made possible with a welding machine according to the invention, wherein a measurement or regulation of a temperature of the welding region is no longer required, especially for the heat treatment.

A welding machine with the following features is also disclosed:

A welding machine for welding two components of a track for rail vehicles by means of flash butt welding, comprising a welding power source and a programmable controller having a program for welding a certain combination of two components of a track, wherein the program for welding specifies a time sequence of current pulses of the welding power source, wherein a program for heat treatment of the welding region of the two components, preferably for execution on the programmable controller of the welding machine, is provided for controlling the welding power source in temporal relation to a program for welding or is comprised by a program for welding.

The welding machine is preferably further developed in such a way that sequences of current pulses of the welding power source can be programmed in a program for a heat treatment in such a way that uninfluenced cooling, delayed cooling, maintaining a temperature and heating can be achieved for a welding region, wherein residual heat present in the welding region from a previous flash butt welding can be used for heating the welding region, for preferably at least partial austenitization of the microstructure of the welding region.

The welding machine is preferably further developed in such a way that at least one controllable device, preferably via its programmable controller, is provided for accelerated cooling of the welding region.

The welding machine is preferably further developed in such a way that the heat treatment program further comprises the control of the device for accelerated cooling The welding machine is preferably further developed in such a way that a controllable cooling device is designed to blow a gas or gas mixture on at least one section of the welding region for the accelerated cooling thereof.

The welding machine is preferably further developed in such a way that at least one flow rate of a gas or gas mixture or its pressure is controllable by the device for accelerated cooling.

The welding machine is preferably further developed in such a way that, following a flash butt welding, the microstructure of the welding region, preferably the fineness of a pearlitic structure, can be influenced via an attached or integrated program for a heat treatment.

### BRIEF DESCRIPTION OF THE DRAWINGS

The invention is explained in more detail below with reference to an exemplary embodiment schematically illustrated in the drawing.

FIG. 1 shows the course of the force, the current, the path and the temperature of the joining partners moved towards one another during a flash butt welding method according to the invention,

FIG. 2 shows a temperature-time conversion diagram in which the cooling curve is shown during the cooling step,

FIG. 3 shows a temperature-time austenitization diagram in which the heating curve is shown during the reheating step, and

FIG. 4 shows a temperature-time conversion diagram in which cooling curves are shown during a final accelerated cooling.

### DETAILED DESCRIPTION

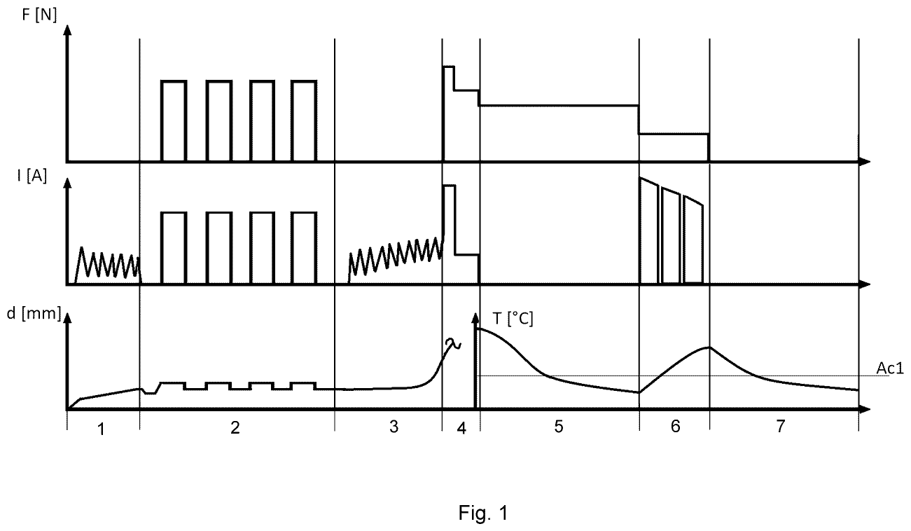

FIG. 1 shows the various phases of a flash butt welding method comprising straight flashing 1, preheating 2, flashing 3 and upsetting 4. After upsetting, a cooling step 5, which in the present example lasts about 180 seconds, follows while maintaining the force with which the two rails are pressed against one another. After cooling step 5, a reheating step 6 is carried out to above the “Ac1” conversion temperature line, in which the welding region is heated resistively by passing a plurality of successive current pulses through, the current intensity being selected to be decreasing and a compressive force acting on the welding region.

The welding region is understood here to mean that longitudinal section of welded components of a track, e.g. rails, which comprises or consists of the welding joint and the heat-affected zones arranged on both sides of the welding joint.

At the end of the heat treatment, for example, the welding region on a rail head is subjected to accelerated cooling 7.

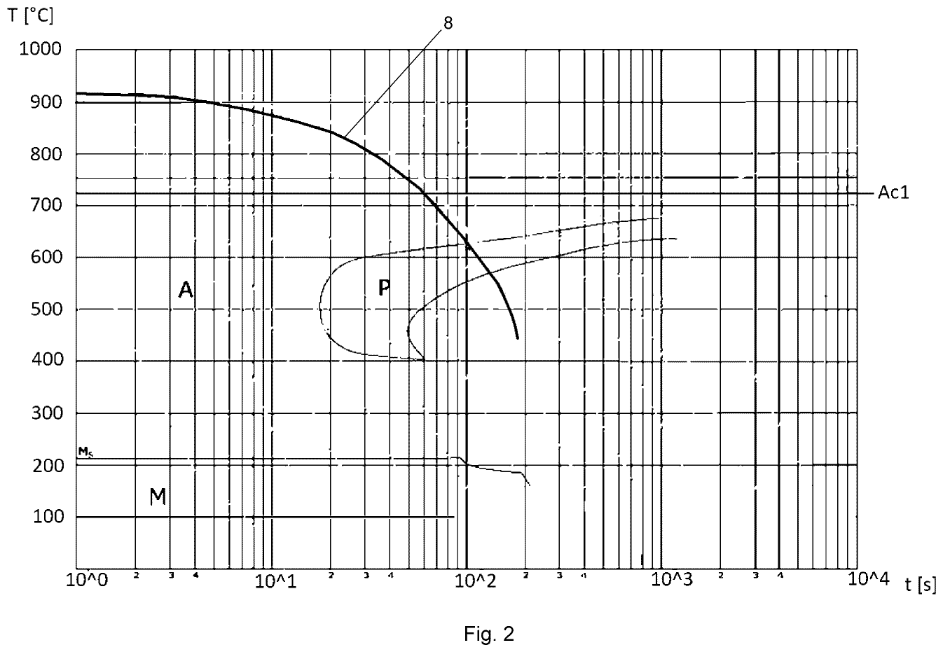

FIG. 2 shows the temperature curve for the cooling step 5, wherein a possible cooling curve 8 is drawn with the line starting at approximately 910° C. The cooling curve 8 represents a cooling over a duration of about 2-3 minutes. In any case, the cooling curve reaches or traverses the pearlite region denoted by “P”, so that the austenite is converted into pearlite. In the present example, the cooling step is terminated at a temperature of less than 500° C.

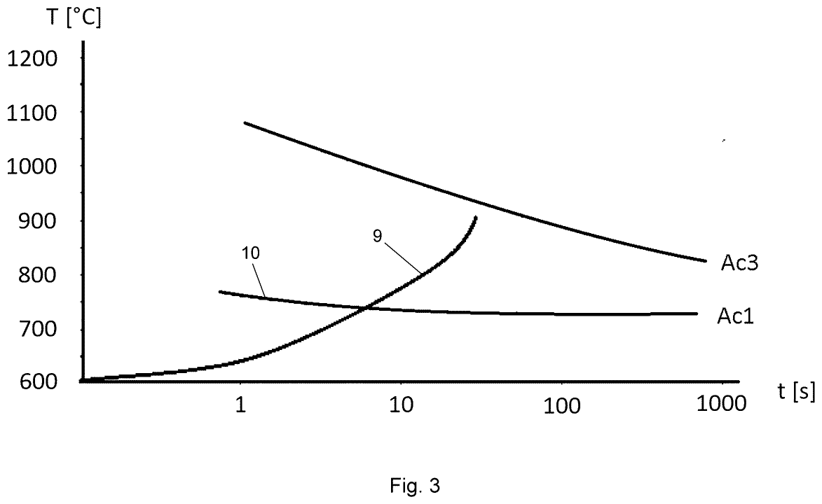

FIG. 3 shows the temperature curve 9 coming from 600° C. during the reheating step 6 and it can be seen that the heating takes place within a period of about 30 seconds to more than the Ac1 conversion temperature 10, wherein in this example an approximately 90 percent austenitization is achieved.

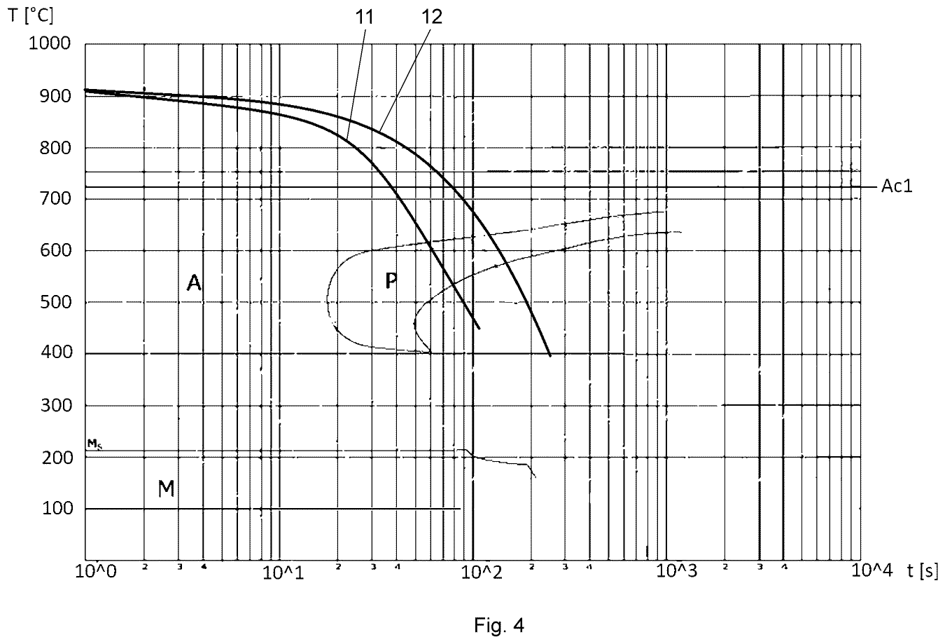

FIG. 4 shows various cooling curves of the accelerated cooling 7 following the reheating 6. Here, curve 11 shows a profile of accelerated cooling of the rail head at a faster cooling speed, and curve 12 shows a profile of accelerated cooling of the associated rail foot at a slower cooling speed.

1-25. (canceled)

26. A method for welding components, which can be travelled upon, of a track by flash butt welding in a welding device, comprising:
straight flashing;
preheating;
flashing; and
upsetting;
wherein the upsetting process generates a welding region, whereupon the welding region, from the welding heat, is subjected to a cooling step in which an austenitic structure of the welding region is converted into a pearlite structure, whereupon the welding region is subjected to a reheating step in which the welding region is heated to above the Ac1 conversion temperature;
wherein the heating is performed by electrical resistance heating in the welding device using a welding power source that is used for the straight flashing, preheating and flashing, whereupon a region of the component coming into contact with a wheel is subjected to accelerated cooling in the welding region, and a region not coming into contact with the wheel is subjected to slower cooling in the welding region than the region of the component coming into contact with the wheel.

27. The method according to claim 26, wherein the region of the component coming into contact with the wheel comprises a rail head

28. The method according to claim 26, wherein the region not coming into contact with the wheel comprises a rail foot,

29. The method according to claim 26, wherein a direct current is passed through the welding region for the electrical resistance heating.

30. The method according to claim 26, wherein the cooling step is carried out to a temperature of the welding region of less than 500° C.

31. The method according to claim 26, wherein the duration of the cooling step is 120-240 seconds.

32. The method according to claim 26, wherein the reheating step is started immediately after completion of the cooling step and at a temperature of the welding region of between 400° C. and 500° C.

33. The method according to claim 32, wherein the reheating step is performed at a fixed temporal distance from the welding step.

34. The method according to claim 26, wherein the duration of the reheating step is a maximum of 30 seconds.

35. The method according to claim 26, wherein the reheating step is carried out at an average heating rate of 13-20°C./sec.

36. The method according to claim 26, wherein the welding region is heated to a temperature of >850° C. in the reheating step.

37. The method according to claim 26, wherein the accelerated cooling is carried out to a temperature of less than 500° C.

38. The method according to claim 37, wherein the accelerated cooling is carried out to a temperature of less than 400° C.

39. The method according to claim 37, wherein the duration of the accelerated cooling is 80-150 seconds.

40. The method according to claim 26, wherein the accelerated cooling is effected by forced convection of a cooling gas.

41. The method according to claim 26, wherein the rails consist of a hardenable rail steel having a carbon content of >0.75%.

42. A welding device for welding components, which can be travelled upon, of a track by flash butt welding, comprising:
a welding power source;
a feed device for pressing the track components against one another;
a programmable control unit for controlling a time sequence of current pulses of the welding power source and a feed movement of the feed device; and
a cooling device for accelerated cooling of a welding region
wherein the control unit is configured to control the feed device and the welding power source in a welding phase in order to perform straight flashing, preheating, flashing, and upsetting, the welding region being generated by the upsetting process;
wherein the control unit is configured to control the welding power source in a subsequent reheating phase to perform a reheating step, and to start the reheating step after a cooling step in which the welding region is cooled from the welding heat; and
wherein the control unit interacts with the cooling device so that the region coming into contact with a wheel is subjected to accelerated cooling in the welding region after the reheating step, and a region not coming into contact with the wheel is subjected to slower cooling in the welding region than the region of the component coming into contact with the wheel.

43. The welding device according to claim 42, wherein the cooling device is configured to blow a gas or gas mixture on at least one section of the welding region for the accelerated cooling thereof.

44. The welding device according to claim 43, wherein at least one of:
at least one flow rate of the gas or gas mixture is controllable by the cooling device; and
at least one pressure of the gas or gas mixture is controllable by the cooling device.

45. The welding device according to claim 42, wherein the control unit is configured to carry out the accelerated cooling to a temperature of less than 500° C.
